(19) United States
(12) Patent Application Publication
(10) Pub. No.: US 2026/0296516 A1
(43) Pub. Date: Oct. 1, 2026

(54) CHILD STROLLER

(71) Applicant: CH BABY CO., LTD, ShaoXing (CN)

(72) Inventors: Jianhua FAN, ShaoXing (CN); Guoxian YU, ShaoXing (CN); Congquan MA, ShaoXing (CN)

(21) Appl. No.: 19/577,390

(22) Filed: Mar. 25, 2026

(30) Foreign Application Priority Data
Mar. 25, 2025 (CN) 202520544348.0

(51) Int. Cl. B62B 7/06; B62B 7/00; B62B 7/08; B62B 9/20

(52) U.S. Cl. CPC B62B 7/062; B62B 7/006; B62B 7/08; B62B 9/20

(57) ABSTRACT

A child stroller has an unfolded state and a folded state. It includes a frame with wheels and a seat assembly on the frame. The frame has rotatably connected front and rear leg assemblies and a push handle assembly rotatably connected to the rear leg assembly. The seat assembly has a seat and a backrest rotatably connected to the seat's rear end. In the folded state, the front leg assembly, push handle assembly, and backrest rotate toward and adjacent to the rear leg assembly. The seat includes a seat support frame with rotatably connected front and rear parts. The rear part is rotatably connected to the front leg assembly. A linkage is between the front part and front leg assembly. A limiting member between the front and rear parts restricts their relative rotation during folding, enabling the front part to drive the rear part to rotate together.

### CROSS-REFERENCE TO RELATED APPLICATIONS

This application claims priority of Chinese Utility Model Application No. 202520544348.0, filed on Mar. 25, 2025. The contents of which are incorporated herein by reference.

### TECHNICAL FIELD

The present disclosure relates to outdoor articles, and in particular, to a child stroller.

### BACKGROUND

Foldable child strollers known in the art, for example, the Chinese Utility Model patent with publication No. CN221794732U discloses a baby stroller comprising a folding mechanism, a backrest, and coaxially hinged front supports, rear supports, and a push handle assembly. The folding mechanism includes mutually hinged front and rear seat plates, and a seat plate support. The front seat plate, the rear seat plate, the front supports, and the seat plate support form a four-bar linkage structure. The backrest is rotatably connected to the rear seat plate, the push handle assembly is connected to the folding mechanism, a locking member is connected to the folding mechanism, and the rear supports are connected to the folding mechanism. In the unfolded state, the front and rear seat plates are coplanar to provide a flat upper surface for a child to sit on. In the folded state, the push handle assembly is folded rearward to be positioned adjacent to the rear supports, the front supports pivot rearward to be positioned adjacent to the rear supports, and the four-bar linkage folds. Driven by the backrest, the front and rear seat plates fold relative to each other, finally causing the front and rear seat plates to be completely tilted. On one hand, the backrest is too close to the ground. To prevent the backrest from being near the ground, the length of the backrest must be correspondingly shortened. On the other hand, the folded stroller has a triangular outer contour, lacking aesthetic simplicity.

### SUMMARY

The present disclosure provides a child stroller which can allow for an increased backrest length.

A child stroller, having an unfolded state and a folded state, the child stroller including a stroller frame with wheels at a bottom thereof and a seat assembly arranged on the stroller frame, the stroller frame including a front leg assembly, a rear leg assembly and a push handle assembly, the front leg assembly and the rear leg assembly being rotatably connected, the push handle assembly and the rear leg assembly being rotatably connected, and the seat assembly including a seat and a backrest rotatably connected to a rear end of the seat; wherein in the folded state, the front leg assembly, the push handle assembly, and the backrest rotate toward and are positioned adjacent to the rear leg assembly; and
wherein the seat includes a seat support frame, the seat support frame includes a front part and a rear part hinged to each other, the front part and the rear part are coplanar in the unfolded state, the rear part is hinged to the front leg assembly, and one or more first linkages are provided between the front part and the front leg assembly; and a limiting member is provided between the front part and the rear part for restricting relative rotation between the front part and the rear part during folding, so that the front part is capable of driving the rear part to rotate together.

The following are several optional configurations, which are not to be understood as additional limitations to the above overall solution, but merely as further supplements or preferences. In the absence of technical or logical contradictions, each optional configuration can be combined individually with the above overall solution, or multiple optional configurations can be combined with each other.

Optionally, the seat includes a seat cushion covering an upper surface of the seat support frame, and the seat cushion serves as the limiting member.

Optionally, the backrest includes a backrest support frame and a back cushion covering an upper surface of the backrest support frame, and the seat cushion is connected to the back cushion.

Optionally, a flexible enclosure is provided between the back cushion and the push handle assembly, and wherein the seat cushion, the back cushion, and the flexible enclosure collectively enclose a seating space that is open at a front side thereof.

Optionally, in the folded state, the rear part is arranged to be perpendicular to the rear leg assembly.

Optionally, in the folded state, the rear leg assembly is substantially arranged vertically, and a bottom of the backrest is suspended.

Optionally, a limiting mechanism is disposed between the front part and the rear part for restricting one-way rotation and maintaining coplanarity therebetween, and the stroller frame is provided with a limiting portion that cooperates with the rear part to restrict the entire seat support frame from rotating backward.

Optionally, a pivot center axis of the front leg assembly and the rear leg assembly coincides with a pivot center axis of the front leg assembly and the rear part.

Optionally, the stroller further includes a front handrail rod with two ends hinged to the push handle assembly, wherein the front handrail rod and the rear leg assembly are linked in motion, and in the folded state, the front handrail rod is arranged vertically.

Optionally, the stroller includes a push handle assembly rotatably connected to the rear leg assembly, and in the folded state, the push handle assembly rotates towards and is positioned adjacent to the rear leg assembly.

Optionally, the front leg assembly includes a pair of front leg rods, the rear leg assembly includes a pair of rear leg rods, the push handle assembly includes a pair of push rods, each front leg rod is provided with a front leg joint a top thereof, each rear leg rod is provided with a rear leg joint at a top thereof, and each push rod is provided with a push rod joint at a bottom thereof, wherein the seat assembly is disposed between two side frames, each side frame is formed by one of the pair of front leg rods, one of the pair of push rods, and one of the pair of rear leg rods that are located on a same side and connected through corresponding joints; and wherein, for each side frame, the rear leg joint of the rear leg rod is rotatably connected to the front leg joint of the front leg rod and the push rod joint of the push rod, and a flexible enclosure is disposed between the backrest and the push handle assembly.

Optionally, a flexible enclosure is provided between the backrest and the push handle assembly.

In the child stroller of the present disclosure, in the folded state, a rear side of the rear part moves upward to lift the backrest. The lifted backrest is farther from the ground, allowing for an adaptively increased backrest length.

### BRIEF DESCRIPTION OF THE DRAWINGS

FIG. 1 is a structural view of a stroller frame of a child stroller in an unfolded state according to an embodiment of the present disclosure.

FIG. 2 is a structural view of the child stroller illustrated in FIG. 1 with its push handles folded.

FIG. 3 is a structural view of the stroller frame of the child stroller illustrated in FIG. 1 in a folded state.

FIG. 4 is a structural view of the child stroller in an unfolded state according to an embodiment of the present disclosure.

FIG. 5 is an enlarged view of a joint region among a front leg assembly, a rear leg assembly, and a push handle assembly of the child stroller in FIG. 1, with a rear leg joint housing removed.

FIG. 6 is an exploded view of the front leg assembly, the rear leg assembly, and the push handle assembly of FIG. 5.

FIG. 7 is a cross-sectional view of the child stroller illustrated in FIG. 2 taken along a plane of symmetry.

FIG. 8 is a cross-sectional view of the child stroller illustrated in FIG. 7 in a folded state.

FIG. 9 is a cross-sectional view of the child stroller illustrated in FIG. 8 after a leg rest support frame is rotated and folded.

List of reference signs:
frame 10; side frame 100; front leg assembly 110; front wheel 111; front leg rod 112; front leg joint 113; first connecting portion 114; second connecting portion 115;
rear leg assembly 120; rear wheel 121; rear leg rod 122; rear leg joint 123; hook 124;
push handle assembly 130; push rod 132; push rod joint 133; first linkage 140; second linkage 150; limiting portion 160; first transverse connector 171; second transverse connector 172; front handrail rod 180;
seat assembly 200; seat 210; seat support frame 220; front part 221; rear part 222; backrest 230; backrest support frame 231; leg rest support frame 240; limiting mechanism 250;
seat cushion 310; back cushion 320; flexible enclosure 330; leg cushion 340.

### DESCRIPTION OF THE EMBODIMENTS

The technical solutions in the embodiments of the present disclosure will be clearly and completely described below with reference to the accompanying drawings in the embodiments of the present disclosure. It is apparent that the described embodiments are merely a part of the embodiments of the present disclosure, but not all of the embodiments. All other embodiments obtained by a person skilled in the art based on the embodiments of the present disclosure without creative efforts shall fall within the scope of the present disclosure.

It should be noted that when a component is referred to as being “connected” to another component, it can be directly connected to the other component or intervening components may be present. When a component is considered to be “disposed” on another component, it can be directly disposed on the other component or an intervening component may be present.

Unless otherwise defined, all technical and scientific terms used herein have the same meaning as commonly understood by a person skilled in the art to which this disclosure belongs. The terms used in the description of the present disclosure are for the purpose of describing particular embodiments only and are not intended to limit the present disclosure. The term “and/or” as used herein includes any and all combinations of one or more of the associated listed items.

In the present disclosure, terms such as “first” and “second” are used for descriptive purposes only and are not to be understood as indicating or implying relative importance or implicitly specifying the number or order of the indicated technical features. Thus, features defined with “first” and “second” may explicitly or implicitly include one or more of the features. In the description of the present disclosure, the term “a plurality” means at least two, for example, two, three, etc., unless otherwise expressly limited.

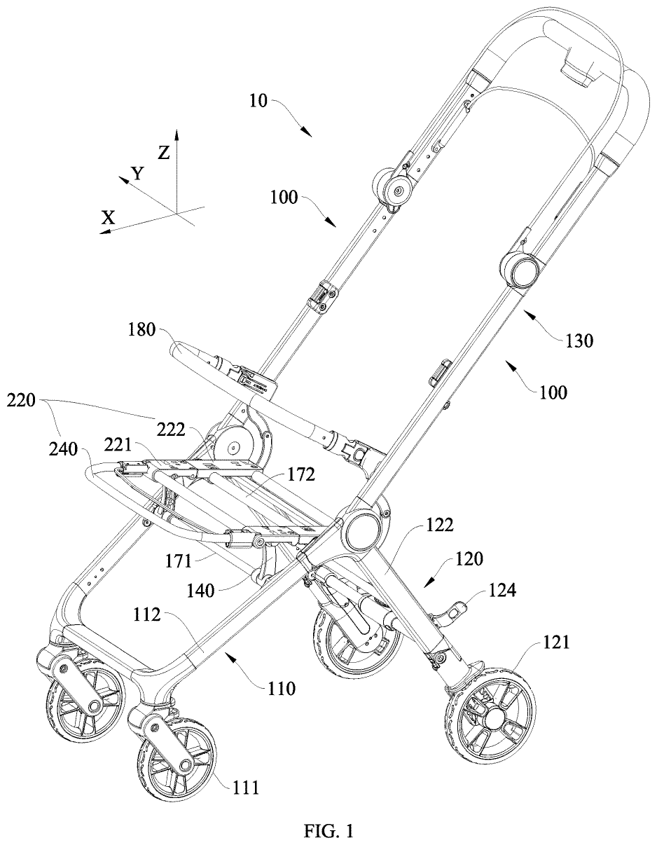

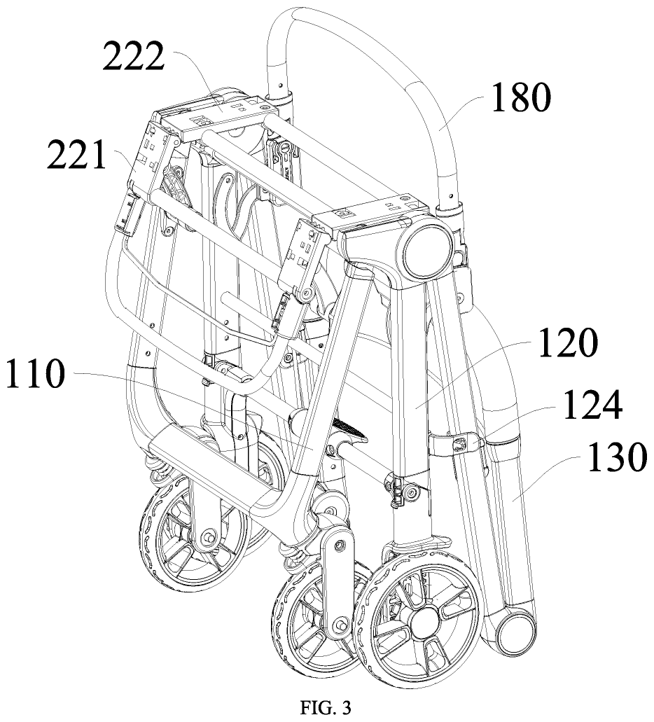

With reference to FIGS. 1 to 4, a foldable child stroller has an unfolded state and a folded state. The child stroller includes a frame 10 with wheels at a bottom thereof and a seat assembly 200 arranged on the frame 10 for a child to sit. For a clearer illustration, the child stroller is defined as having the X, Y, and Z directions shown in FIG. 1, corresponding respectively to the length, width, and height directions.

The frame 10 includes a front leg assembly 110 and a rear leg assembly 120 that are rotatably connected. The front leg assembly 110 and the rear leg assembly 120 are rotatable relative to each other about a first horizontal axis. In some embodiments, the frame 10 further includes a push handle assembly 130 rotatably connected to the rear leg assembly 120. The push handle assembly 130 and the rear leg assembly 120 are rotatable relative to each other about a second horizontal axis. In some embodiments, the first axis and the second axis are not coaxial. In some embodiments, the first axis and the second axis are coaxial.

As shown in FIG. 1, in some embodiments, a top of the front leg assembly 110 and a bottom of the push handle assembly 130 are both rotatably connected to a top of the rear leg assembly 120. A bottom of the front leg assembly 110 is provided with front wheels 111 capable of universal rotation, a bottom of the rear leg assembly 120 is provided with rear wheels 121 for directional travel, and a top of the push handle assembly 130 is provided with grips.

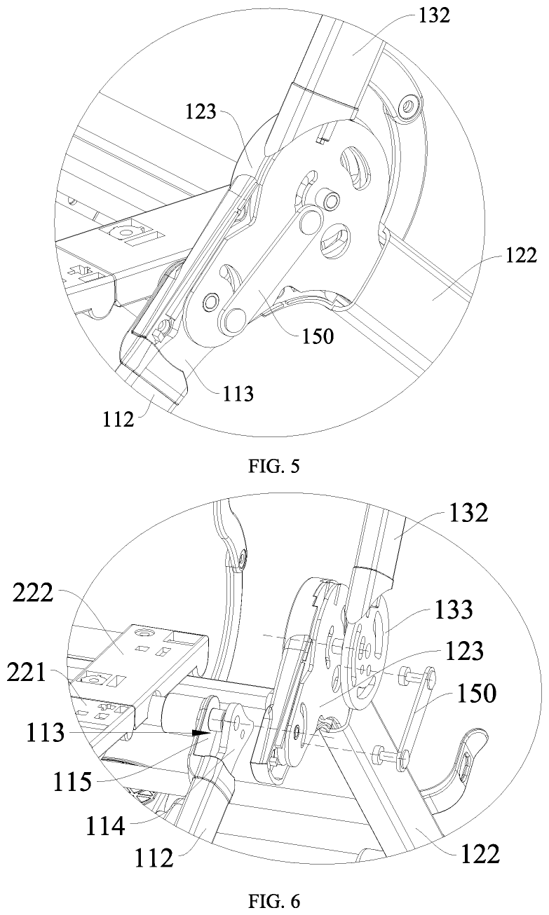

To achieve linked folding of the push handle assembly 130 and the front leg assembly 110, a linkage mechanism is disposed between the push handle assembly 130 and the front leg assembly 110. In some embodiments, as shown in FIGS. 5 and 6, the linkage mechanism includes a second linkage 150 disposed between a bottom of the push handle assembly 130 and a top of the front leg assembly 110. Two ends of the second linkage 150 are rotatably connected to the push handle assembly 130 and the front leg assembly 110, respectively. When the push handle assembly 130 rotates toward the rear leg assembly 120, it can drive, via the second linkage 150, the front leg assembly 110 to rotate toward the rear leg assembly 120.

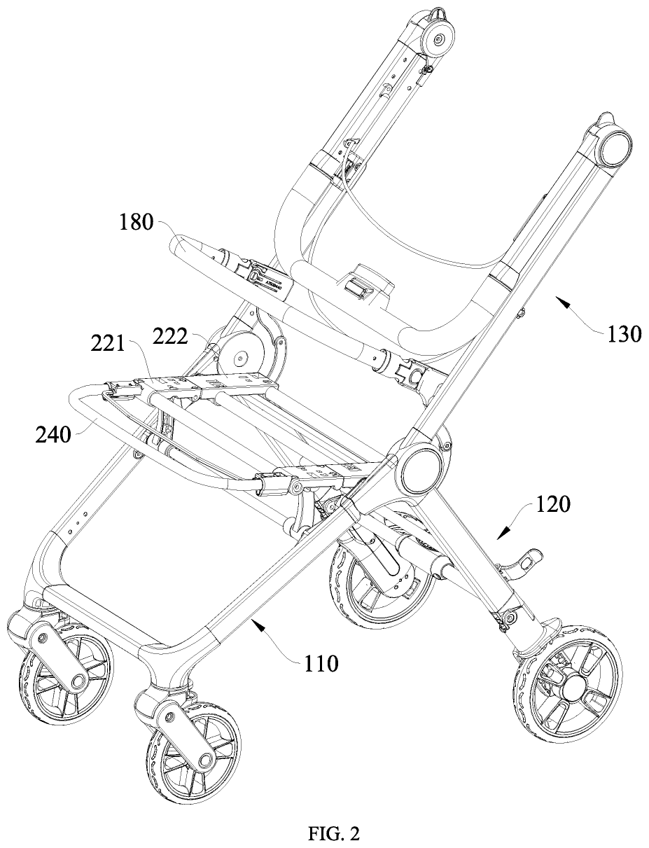

As shown in FIGS. 1 and 2, in the unfolded state, the front leg assembly 110, starting from its bottom, is inclined upward from front to rear. The rear leg assembly 120, starting from its top, is inclined downward from front to rear. In the folded state, the front leg assembly 110 rotates from the front side toward the rear leg assembly 120. In some embodiments, the frame 10 includes the push handle assembly 130. The push handle assembly 130, starting from its bottom, is inclined upward from front to rear. During folding, the push handle assembly 130 rotates from the rear side toward the rear leg assembly 120.

The child stroller includes a locking member to keep it in the unfolded state. In some embodiments, the locking member is slidably arranged at a bottom of the push handle assembly 130. The locking member is movable between an unlocked position and a locked position. A top of the rear leg assembly 120 is provided with a locking groove. When the locking member is in the locked position, an end thereof extends into the locking groove, restricting relative rotation between the push handle assembly 130 and the rear leg assembly 120. When the locking member is in the unlocked position, its end withdraws from the locking groove, allowing the push handle assembly 130 and the rear leg assembly 120 to rotate relative to each other for folding.

The child stroller includes an elastic member acting on the locking member. The elastic member holds the locking member in the locked state. When the locking member moves from the locked position to the unlocked position, the elastic member is compressed. When the locking member moves from the unlocked position to the locked position, the elastic member returns to its initial state.

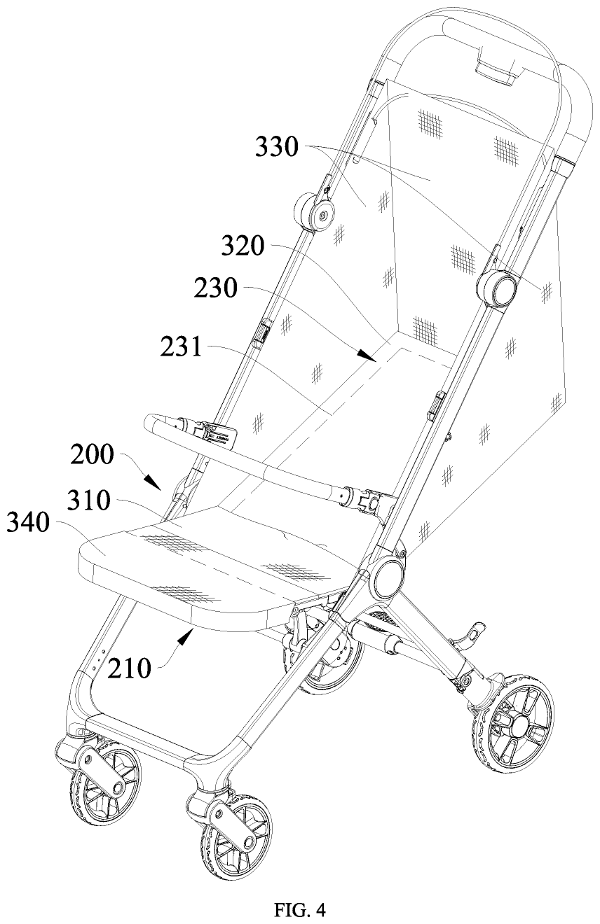

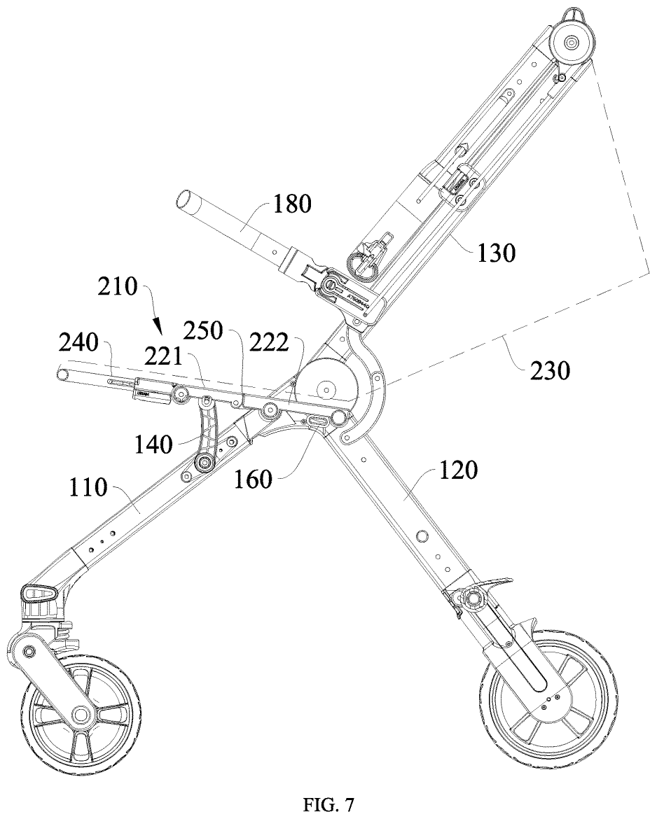

As shown in FIGS. 4 and 7, the seat assembly 200 includes a seat 210 and a backrest 230 rotatably connected to a rear end of the seat 210. The inclination angle of the backrest 230 can be adjusted to accommodate different sitting postures.

As shown in FIG. 1, the seat 210 includes a seat support frame 220 formed by interconnected rods. To improve strength and comfort, a support plate may also be provided on the frame structure formed by the rods.

The seat support frame 220 includes a front part 221 and a rear part 222 rotatably connected to each other. The rear part 222 is rotatably connected to the front leg assembly 110. One or more first linkages 140 are disposed between the front part 221 and the front leg assembly 110. In some embodiments, as shown in FIG. 7, two ends of the first linkage 140 are rotatably connected to the front part 221 and the front leg assembly 110, respectively. The front part 221, the rear part 222, the front leg assembly 110, and the first linkage 140 constitute a foldable four-bar linkage mechanism.

As shown in FIGS. 1 and 2, in the unfolded state, the front part 221 and the rear part 222 of the seat support frame 220 are arranged coplanar. “Coplanar” means that their upper surfaces are substantially in the same plane, but are not limited to being in the same horizontal plane.

Because the four-bar linkage is inherently unstable, the seat support frame 220 may deform under external force. To maintain the coplanarity of the front part 221 and the rear part 222, a limiting mechanism 250 is disposed between them. The limiting mechanism 250 restricts the front part 221 from rotating relative to the rear part 222 in a clockwise direction. In some embodiments, the front part 221 and the rear part 222 are connected by a hinge. The front part 221 has a first end face towards the rear part 222, and the rear part 222 has a second end face towards the front part 221. When the front part 221 and the rear part 222 are coplanar, the first end face and the second end face abut against each other so as to form the limiting mechanism 250, restricting relative rotation between the front part 221 and the rear part 222.

As shown in FIG. 7, the frame 10 is provided with a limiting portion 160 that engages with the rear part 222. In some embodiments, the limiting portion 160 is a transverse rod disposed between the two rear leg assemblies 120. The transverse rod abuts against the rear part 222 to restrict the entire seat support frame 220 from rotating backward. The combined action of the limiting mechanism 250 and the limiting portion 160 keeps the front part 221 and the rear part 222 coplanar in the unfolded state.

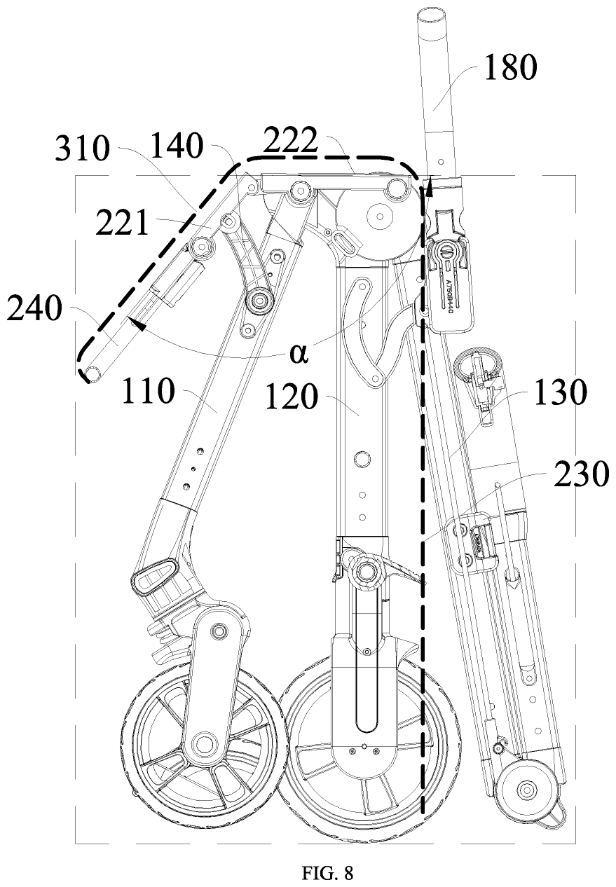

A limiting member is disposed between the front part 221 and the rear part 222. The limiting member is used to restrict the front part 221 from rotating relative to the rear part 222 in a counterclockwise direction. During the folding process, i.e., after the front part 221 rotates relative to the rear part 222 by a certain angle, the limiting member acts on the front part 221 and the rear part 222 to restrict their relative rotation, for example, maintaining an angle α (the angle between the top surfaces of the front part 221 and the rear part 222) as shown in FIG. 8. The front part 221 can then drive the rear part 222 to rotate together, causing a rear end of the rear part 222 to lift upward, thereby lifting the backrest 230 (as indicated by the dashed lines in FIG. 8). After being lifted, the backrest 230 is farther from the ground, allowing it to be further lengthened.

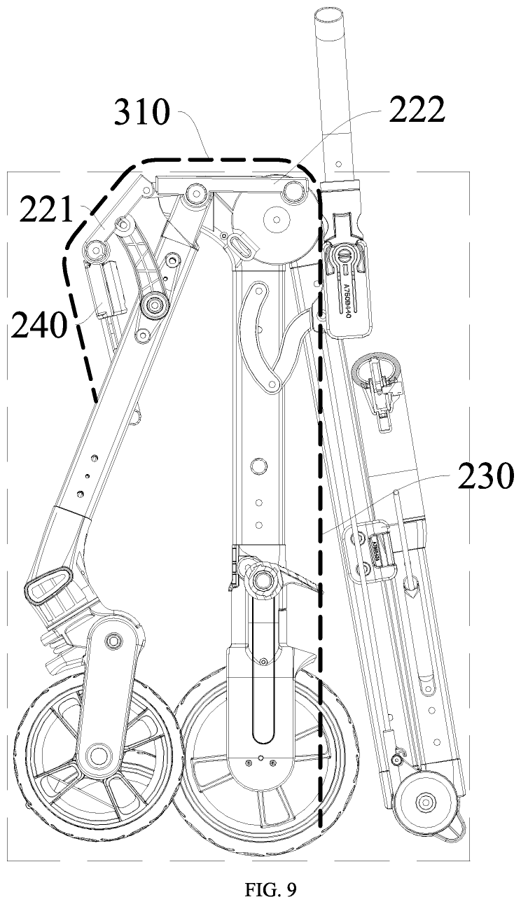

As shown in FIGS. 8 and 9, in the folded state, the rear leg assembly 120 is substantially vertical. In some embodiments, a bottom of the backrest 230 is suspended in the air, preventing the backrest 230 from becoming soiled. In other embodiments, the rear part 222 is arranged substantially perpendicular to the rear leg assembly 120.

Referring to FIG. 4, the seat 210 includes a seat cushion 310 covering an upper surface of the seat support frame 220. In this embodiment, the seat cushion 310 constitutes the limiting member. The non-stretchable nature of the seat cushion 310 is utilized to restrict relative rotation between the front part 221 and the rear part 222. In some embodiments, the seat cushion 310 includes a seat cushion protective layer and a seat cushion elastic layer. The seat cushion elastic layer may be made of elastic material such as sponge. The seat cushion protective layer may be a fabric of a certain thickness. The fabric is bendable and has a low elongation rate, causing the seat cushion 310 to become taut during folding of the child stroller, thereby applying a force between the front part 221 and the rear part 222 to serve as a limiting function.

In some embodiments, the backrest 230 includes a backrest support frame 231 (shown in dashed lines in the figures) and a back cushion 320 covering an upper surface of the backrest support frame 231. The back cushion 320 includes a back cushion protective layer and a back cushion elastic layer. The back cushion elastic layer may be made of elastic material such as sponge. The back cushion protective layer similarly employs a flexible fabric and is connected to the seat cushion protective layer or integrally formed with the seat cushion protective layer as a one-piece structure.

To prevent the seat cushion 310 from shifting relative to the seat support frame 220, in some embodiments, they may be fixedly connected via fasteners or ties.

In one embodiment, the seat 210 further includes a leg rest support frame 240 rotatably connected to a front side of the seat support frame 220, and a leg cushion 340 covering a surface of the leg rest support frame 240. The leg rest support frame 240 is rotatably connected to the front part 221, and a locking element restricting their rotation angle is disposed therebetween. The leg rest support frame 240 can be substantially coplanar with the front part 221 or form a certain angle with it, as shown for example in FIG. 9. The leg cushion 340 includes a leg cushion protective layer and a leg cushion elastic layer. The leg cushion elastic layer is sponge. The leg cushion protective layer wraps around the periphery of the leg cushion elastic layer and is a flexible fabric. The leg cushion protective layer is integrally formed as a one-piece structure with the seat cushion protective layer or the two are connected by stitching.

In some embodiments, the front leg assembly 110 includes a pair of front leg rods 112. The rear leg assembly 120 includes a pair of rear leg rods 122. A top of each front leg rod 112 is provided with a front leg joint 113. A top of each rear leg rod 122 is provided with a rear leg joint 123. Each front leg joint 113 is rotatably connected to one corresponding rear leg joint 123 about the first axis.

In some embodiments, the frame 10 includes the push handle assembly 130. The push handle assembly 130 includes a pair of push rods 132. A bottom of each push rod 132 is provided with a push rod joint 133. Each push rod joint 133 is rotatably connected to one corresponding rear leg joint 123 about the second axis. The seat assembly is disposed between two side frames 100, each of which is formed by one of the pair of front leg rods 112, one of the pair of push rods 122, and one of the pair of rear leg rods 132 on a same side. For each side frame, the front leg rod 112, the rear leg rod 122, and the push rod 132 are connected via corresponding joints to constitute the side frame 100.

In some embodiments, as shown in FIG. 4, a flexible enclosure 330 is disposed between the backrest 230 and the push handle assembly 130. The flexible enclosure 330 is connected to the back cushion protective layer. The seat cushion 310, the back cushion 320, and the flexible enclosure 330 collectively define a seating space that is open at a front side.

In some embodiments, a first transverse connector 171 is connected between the two side frames 100. Two first linkages 140, each of which is a rod member, are provided. One end of each is rotationally mounted on the periphery of the first transverse connector 171, and the other end is rotatably connected to a back side of the front part 221.

In some embodiments, each front leg joint 113 has a first connecting portion 114 extending into the rear leg joint 123, and a second connecting portion 115 located inside the rear leg joint 123. The first connecting portion 114 and the second connecting portion 115 are rotatably connected to the rear leg joint 123 via a pivot shaft.

Furthermore, a second transverse connector 172 is disposed between the two second connecting portions 115. The rear part 222 is rotationally mounted around the second transverse connector 172. In one embodiment, an axis of the second transverse connector 172 is coaxial or non-coaxial with the axis of the pivot shaft. This can also be understood as the pivot center axis between the front leg assembly 110 and the rear leg assembly 120 coinciding or not coinciding with the pivot center axis between the front leg assembly 110 and the rear part 222.

In some embodiments, each push rod 132 is a two-fold structure. In the folded state, the push rods 132, after being folded, together with the rear wheels 121, supports the stroller on the ground. The rear leg rods 122 are substantially in a vertical orientation. The folded push rods 132 closely abut the rear leg rods 122.

A second linkage 150 is disposed between the bottom of the push handle assembly 130 and the top of the front leg assembly 110. In some embodiments, the second linkage 150 is a rod member and is arranged inside the rear leg joint 123. The second linkage 150 and the push rod joint 133 are rotatably connected about a third axis. The second linkage 150 and the front leg joint 113 are rotatably connected about a fourth axis.

In some embodiments, in the folded state, the rear part 222 is located within a space defined by the two rear leg joints 123. That is, when viewed from the Y direction, the rear part 222 is obscured by the rear leg joints 123. Preferably, in the folded state, a top surface of the rear leg joints 123 extend substantially horizontally.

In some embodiments, the child stroller 1000 further includes a front handrail rod 180 with its two ends rotatably connected to the push handle assembly 130. The front handrail rod 180 provides safety protection for a seated child. Furthermore, the front handrail rod 180 and the rear leg assembly 120 are linked in motion. An example of the linkage structure is shown in FIG. 7, where a two-fold rod is rotatably connected between the front handrail rod 180 and the rear leg assembly 120. In the folded state, the front handrail rod 180 is in a vertical orientation, allowing a user to grasp it for transporting the entire stroller.

In one embodiment, in the unfolded state, the front part 221 protrudes forward beyond the frame 10, extending the seating length and improving comfort. In the folded state, the front part 221 protrudes forward beyond the front leg assembly 110, causing the overall outer contour of the stroller, when viewed from the Y direction, to be substantially rectangular (as shown in FIG. 8). The overall shape is square for convenient packaging and has a more cleaner appearance. In the figures, for ease of carrying the entire stroller, the front handrail rod 180 protrudes beyond this outer contour in the folded state.

In one embodiment, the child stroller 1000 further includes a hook 124 for retaining the stroller frame 10 in the folded state. Optionally, the hook 124 is disposed on the rear leg rod 122 of the rear leg assembly 120. In the folded state, the hook 124 is detachably connectable to the push rod 132 of the push handle assembly 130 to prevent accidental unfolding of the frame 10 during carrying or transportation.

A folding process of the child stroller according to an embodiment of the present disclosure is as follows:

Fold the push rods 132, then rotate the push rods 132 to be positioned adjacent to the rear leg assembly 120. The front leg assembly 110 is driven to rotate to be positioned adjacent to the rear leg assembly 120 via the second linkage 150. During this process, the backrest 230 moves along with the push rods 132. The front leg assembly 110 drives, via the first linkage 140, the front part 221 to rotate relative to the rear part 222 until the seat cushion 310 becomes taut, restricting further rotation of the front part 221. At this point, the frame 10 is not yet fully folded. Continue folding, the front part 221 drives the rear part 222 to continue rotating. A rear side of the rear part 222 moves away from the limiting portion 160 and lifts upward, thereby driving and lifting the backrest 230, until the folded state is reached. Under the gravity of the backrest 230, the rear part 222 is stably maintained in a horizontal state.

In the child stroller of the present disclosure, in the folded state, when viewed along the width direction, the dimensions of the top and bottom of the child stroller are similar, and its outer contour tends to be rectangular, resulting in a more cleaner appearance and facilitating packaging. Furthermore, the rear part 222 remains horizontal, thereby lifting the backrest 230. Compared to the prior art, the backrest 230 is farther from the ground, allowing it to be further lengthened.

The technical features of the above embodiments can be combined arbitrarily. For brevity of description, not all possible combinations of the technical features in the above embodiments are described. However, as long as there is no contradiction in the combination of these technical features, it should be considered as within the scope of this specification. When technical features from different embodiments are illustrated in the same drawing, the drawing can be considered as also disclosing the combined examples involving the respective embodiments.

The foregoing embodiments merely express several implementations of the present disclosure. Their description is specific and detailed, but should not be understood as limiting the scope of the patent application. It should be noted that those skilled in the art can make several modifications and improvements without departing from the concept of the present disclosure, and these all fall within the protection scope of the present disclosure.

What is claimed is:

1. A child stroller, having an unfolded state and a folded state, the child stroller comprising a stroller frame with wheels at a bottom thereof and a seat assembly arranged on the stroller frame, the stroller frame comprising a front leg assembly, a rear leg assembly and a push handle assembly, the front leg assembly and the rear leg assembly being rotatably connected, the push handle assembly and the rear leg assembly being rotatably connected, and the seat assembly comprising a seat and a backrest rotatably connected to a rear end of the seat; wherein in the folded state, the front leg assembly, the push handle assembly, and the backrest rotate towards the rear leg assembly to be positioned adjacent to the rear leg assembly; and
wherein the seat comprises a seat support frame, the seat support frame comprises a front part and a rear part hinged to each other, the front part and the rear part are coplanar in the unfolded state, the rear part is hinged to the front leg assembly, and one or more first linkages are provided between the front part and the front leg assembly; and a limiting member is provided between the front part and the rear part for restricting relative rotation between the front part and the rear part during folding, so that the front part is capable of driving the rear part to rotate together.

2. The child stroller according to claim 1, wherein the seat comprises a seat cushion covering an upper surface of the seat support frame, and the seat cushion serves as the limiting member.

3. The child stroller according to claim 2, wherein the backrest comprises a backrest support frame and a back cushion covering an upper surface of the backrest support frame, and the seat cushion is connected to the back cushion.

4. The child stroller according to claim 3, wherein a flexible enclosure is provided between the back cushion and the push handle assembly, and wherein the seat cushion, the back cushion, and the flexible enclosure collectively enclose a seating space that is open at a front side thereof.

5. The child stroller according to claim 1, wherein in the folded state, the rear part is arranged to be perpendicular to the rear leg assembly.

6. The child stroller according to claim 1, wherein in the folded state, the rear leg assembly is substantially arranged vertically, and a bottom of the backrest is suspended.

7. The child stroller according to claim 1, wherein a limiting mechanism is disposed between the front part and the rear part for restricting one-way rotation and maintaining coplanarity therebetween, and the stroller frame is provided with a limiting portion that cooperates with the rear part to restrict the entire seat support frame from rotating backward.

8. The child stroller according to claim 1, wherein a pivot center axis of the front leg assembly and the rear leg assembly coincides with a pivot center axis of the front leg assembly and the rear part.

9. The child stroller according to claim 1, further comprising a front handrail rod with two ends hinged to the push handle assembly, wherein the front handrail rod and the rear leg assembly are linked in motion, and in the folded state, the front handrail rod is arranged vertically.

10. The child stroller according to claim 1, wherein the front leg assembly comprises a pair of front leg rods, the rear leg assembly comprises a pair of rear leg rods, the push handle assembly comprises a pair of push rods, each front leg rod is provided with a front leg joint a top thereof, each rear leg rod is provided with a rear leg joint at a top thereof, and each push rod is provided with a push rod joint at a bottom thereof;
wherein the seat assembly is disposed between two side frames, each side frame is formed by one of the pair of front leg rods, one of the pair of push rods, and one of the pair of rear leg rods that are located on a same side and connected through corresponding joints; and wherein, for each side frame, the rear leg joint of the rear leg rod is rotatably connected to the front leg joint of the front leg rod and the push rod joint of the push rod.

11. A child stroller, having an unfolded state and a folded state, the child stroller comprising a stroller frame and a seat assembly arranged on the stroller frame, the stroller frame comprising a front leg assembly, a rear leg assembly and a push handle assembly, the front leg assembly and the rear leg assembly being rotatably connected, the push handle assembly and the rear leg assembly being rotatably connected, and the seat assembly comprising a seat and a backrest rotatably connected to a rear end of the seat;
wherein the seat comprises a seat support frame, the seat support frame comprises a front part and a rear part hinged to each other, and the rear part is hinged to the front leg assembly; and
wherein during movement of the child stroller from the unfolded state to the folded state, the front leg assembly and the push handle assembly rotate toward and move adjacent to the rear leg assembly, the front part rotates toward and moves adjacent to the front leg assembly, the backrest rotates toward and moves adjacent to the rear leg assembly, and in the folded state, the rear part is substantially horizontal.

12. The child stroller according to claim 11, wherein a limiting member is disposed between the front part and the rear part, and the limiting member restricts rotation of the front part relative to the rear part after the front part rotates by a certain angle.

13. The child stroller according to claim 12, wherein the seat comprises a seat cushion covering an upper surface of the seat support frame, and the seat cushion serves as the limiting member.

14. The child stroller according to claim 13, wherein the backrest comprises a backrest support frame and a back cushion covering an upper surface of the backrest support frame, and the seat cushion is connected to the back cushion.

15. The child stroller according to claim 11, wherein one or more first linkages are provided between the front part and the front leg assembly.

16. The child stroller according to claim 11, wherein the rear leg assembly is substantially arranged vertically.

17. The child stroller according to claim 11, wherein in the folded state, a bottom of the backrest is suspended.

18. The child stroller according to claim 11, wherein in the unfolded state, the front part and the rear part are coplanar.

19. The child stroller according to claim 11, wherein a pivot center axis of the front leg assembly and the rear leg assembly coincides with a pivot center axis of the front leg assembly and the rear part.
